(19) United States
(12) Patent Application Publication
(10) Pub. No.: US 2022/0136479 A1
(43) Pub. Date: May 5, 2022

(54) THE IMPELLER ASSEMBLY FOR HYDROELECTRIC POWER GENERATION DEVICE

(71) Applicant: Hang Je PARK, Gyeongsangnam-do (KR)

(72) Inventor: Hang Je PARK, Gyeongsangnam-do (KR)

(21) Appl. No.: 17/601,952

(22) PCT Filed: Mar. 30, 2020
(86) PCT No.: PCT/KR2020/004302

§ 371 Date: Oct. 7, 2021

(30) Foreign Application Priority Data
Apr. 12, 2019 (KR) 10-2019-0042979

(51) Int. Cl. F03B 3/12; F03B 11/00; F03B 11/06

(52) U.S. Cl. CPC F03B 3/125; F03B 11/006; F03B 11/06; F05B 2220/706; F05B 2240/50; F05B 2240/57; F05B 2240/60

(57) ABSTRACT

This invention aims to provide the composition of inlet so that the strong output may be provided by rotating with the state of high efficiency as the water falling energy and the flow pressure are simultaneously provided to the impeller and to provide impeller assembly for hydroelectric power generation device maximizing the output efficiency by improving the composition of impeller positively. Namely, this invention inserts the impeller in the main body of cylinder shape that the closed inner space is formed by the cover member, the driving shaft shall be supported in the bearing coupled to the cover member, the impeller installed in the inner space shall be driven by forming the inlet and the outlet in the main body in the impeller assembly for a hydroelectric power generation device; the abovementioned inlet, the fluid like the involute curve shall be supplied from the 12 o'clock direction to the 4 o'clock direction of the main body, the outlet is formed from 6 o'clock direction to 8 o'clock direction, the abovementioned impeller forms the plural fluid tanks opened toward the inner surface of the main body, the moment of rotation of the impeller shall be increased by forming the abovementioned fluid tank in the closed pressuring part is formed in the direction of 4 o'clock direction to 6 o'clock direction.

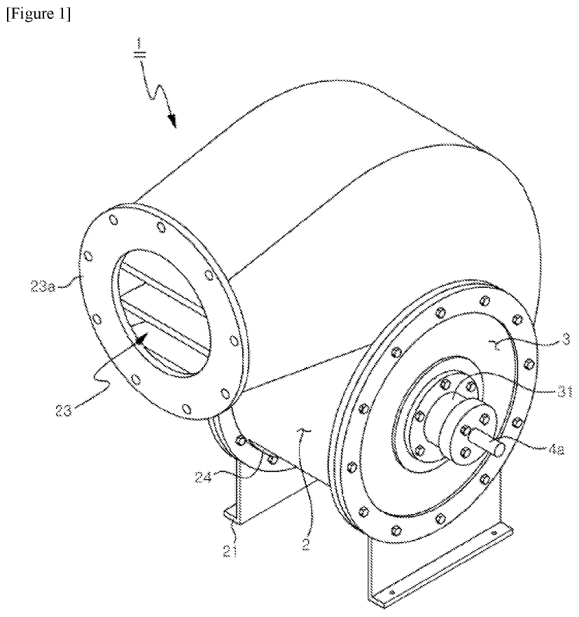

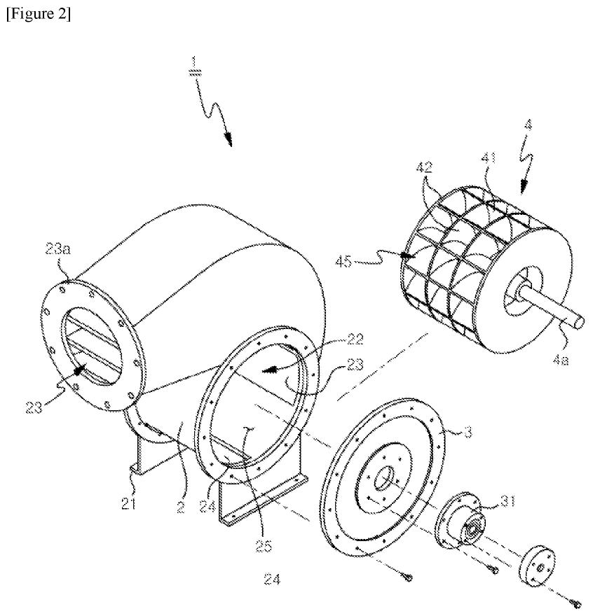

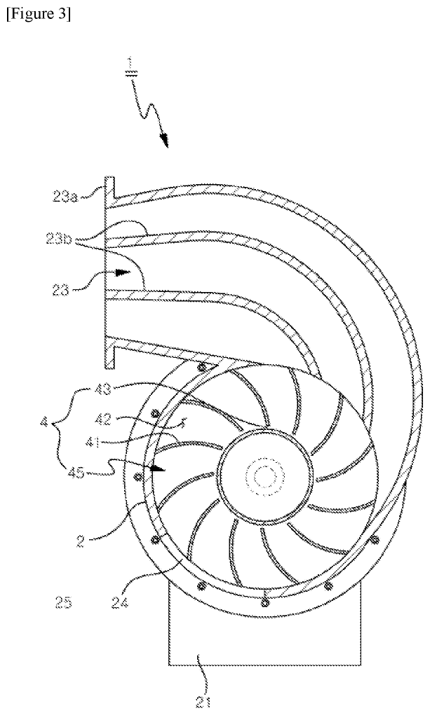

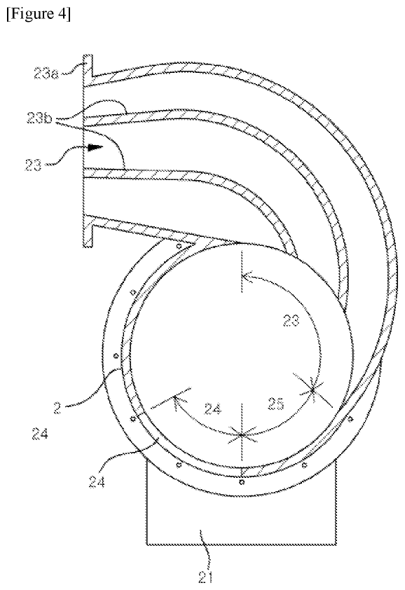

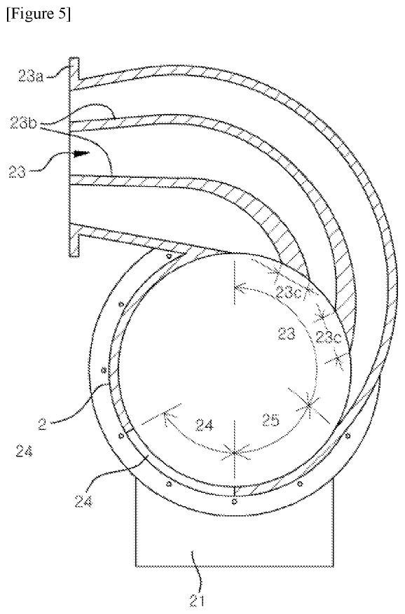

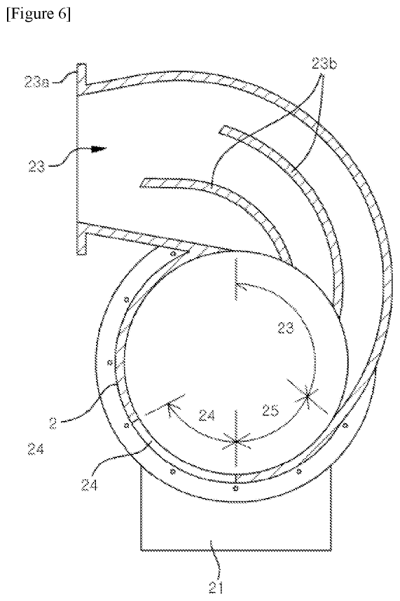

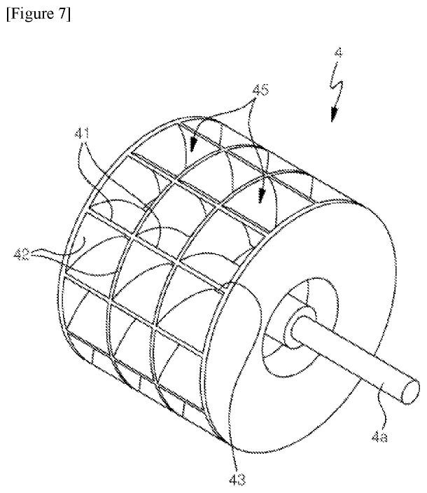

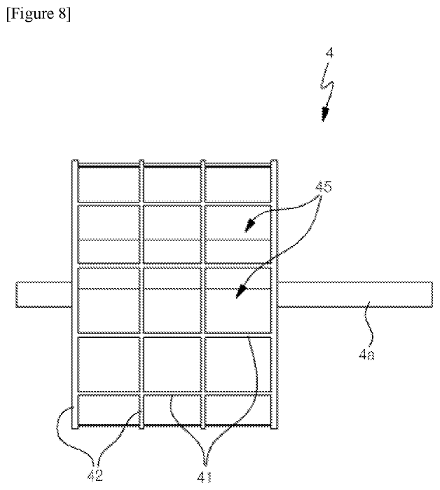

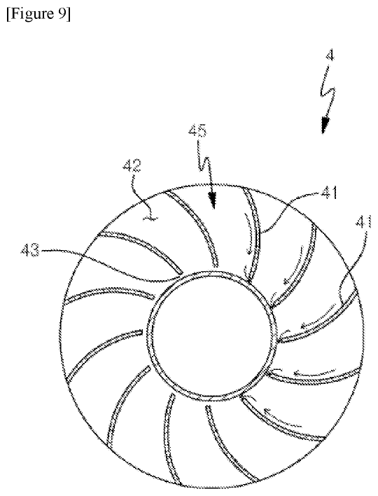

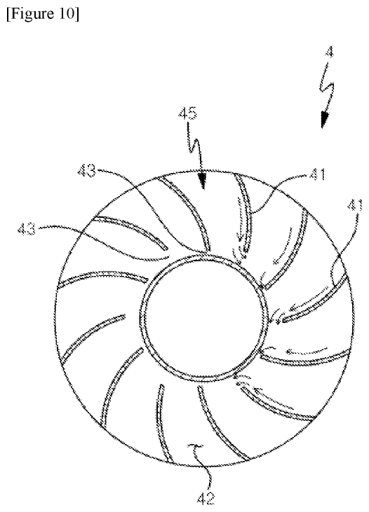

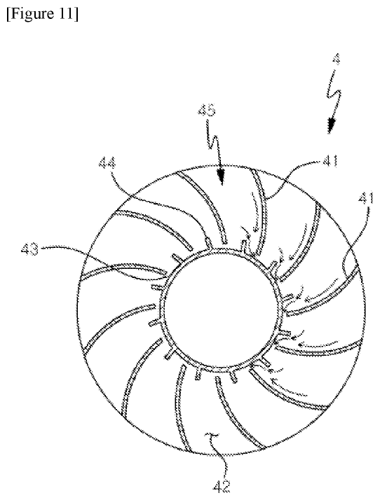

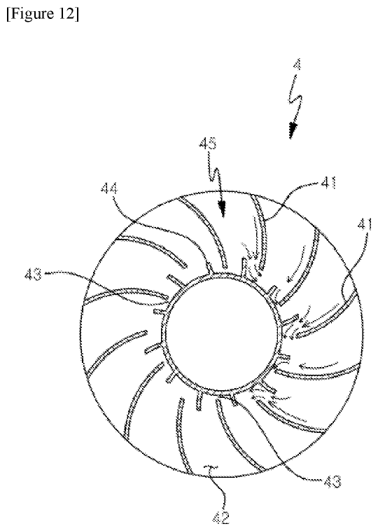

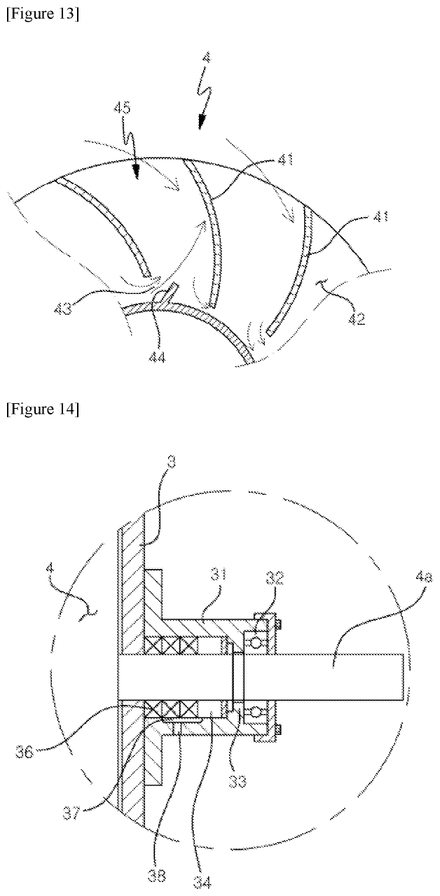

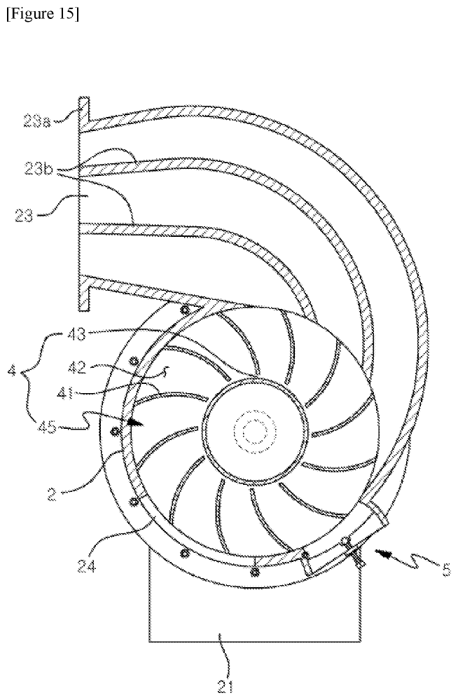

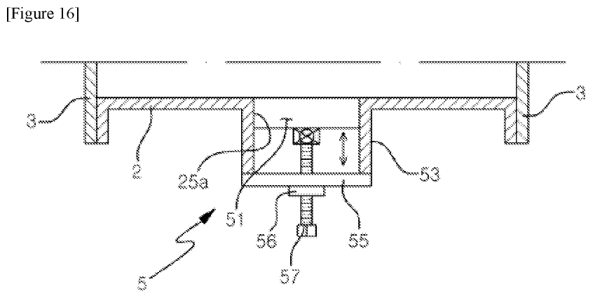

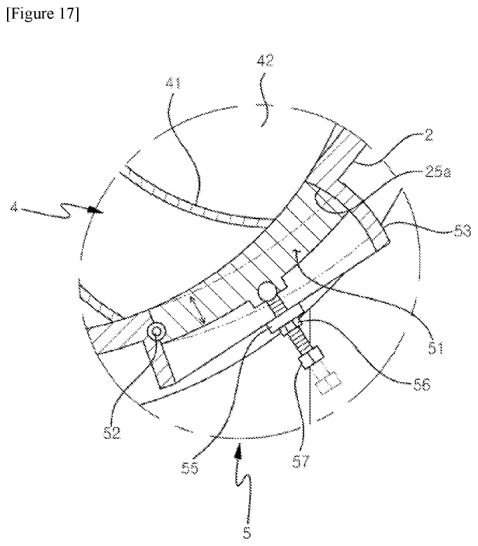

### TECHNICAL FIELD

This invention aims to provide the impeller assembly for a hydroelectric power generation device that maximizes output efficiency by improving the composition of the inlet and the composition of the impeller positively so that it may provide the strong output by rotating with the high efficiency state as the water falling energy and flow pressure are provided to the impeller at the same time more concretely as concerning the impeller assembly for a hydroelectric power generation device.

### BACKGROUND TECHNOLOGY

In case of a hydroelectric power generation device capable of providing the location energy of water with the rotational force, it is widely used as a clean energy without the pollution, power generation devices of diverse composition are provided.

As a representative example, the hydroelectric power generation device with Korean Patent Publication (B1) 10-0837671 (Jun. 13, 2008), the composition of this is composed of an infinite orbit fixedly installed on a structure installed on water, the truck installed in an infinite orbit, the connection piece that is connected to another neighboring truck and a water board installed on each truck, the water board has a slope facing the center in the hydroelectric power generation device that the generator operated by the driving force of the truck, with the hole installed in the center of the water board, the water board is composed to induce the direction of water flowing as the extension part is formed in one slope through the hole in the center as the characteristic.

As an another implementation example, the power generation device of Korean Patent Publication (B1) 10-0534546 (Dec. 8. 2005) is composed of repercussion to be installed in the surface of water, the fixed device suppressing the movement of the abovementioned repercussion and the power generation device, the abovementioned power generation device is composed of the rail of infinite orbit, a lot of pulley moving along with the abovementioned rail, the connector connecting with the abovementioned pulley each other, the wing installed in each of the abovementioned pulley and absorbing the water flow energy to move the pulley, the generator generating the electricity by receiving the movement energy of the abovementioned pulley through the power transfer unit, the abovementioned wing is composed of by installing the water board inside the frame wall, the water board is penetrated and installed in the abovementioned guide bar, is composed of by forming the block chin on both sides of the guide bar.

In case of past hydroelectric power generation device composed of as above, it was hard to make a strong output as it was the structure in which the water pressure is intensively provided only to the water face plate in the front as it has been installed on the surface of water.

Accordingly, this inventor has proposed the hydroelectric power generation device of with Korean Patent Publication (B1) 10-1465724 (Dec. 10, 2014) as a means for solving the above problem.

In case of the abovementioned preceding technology, it provides the supporter being in contact with the ground; the supporter standing vertically so as to be spaced apart from the ground on the upper side of the supporter; the upper and lower axes installed to be axially supported by bearings at upper and lower ends of the support; the generator installed on a support to be coupled through the box to the abovementioned upper shaft and gear box; the upper sprocket and a lower sprocket installed on the upper and lower axes and a chain coupled to these; it is coupled so that the operating space may be formed in front of the abovementioned support and the cover member formed by the type; the attachment rotating by being coupled to the chain pin at regular intervals; it is coupled to the abovementioned attachment and is composed so that the water board passing through the abovementioned operating space with the state of being spaced apart from the front surface of the support and the cover member may be included, provides the hydroelectric power generation device that can be used by installing regardless of the location, such as the waterway, etc., in addition to maximizing the electricity generation by providing the weight and drop of the water with the generator driving force simultaneously and composing to make it compact.

But, in case of the abovementioned composition, there has been the point at issue that a lot of production cost is required, etc. as the composition of equipment is complicated, the use in areas with small quantities or during the dry season was impossible as a certain quantity should be provided continuously.

### DETAILED EXPLANATION OF INVENTION

### Technical Task

Hence, this inventor researches and develops this invention to get rid of all points at issue in the preceding hydroelectric power generation.

Namely, in this invention, the inflow partition wall has been formed within the inlet formed in the main body so that the rotational driving force of the impeller may be enhanced as the pressure of the flow rate together with the falling energy of the incoming flow rate is simultaneously provided to the impeller, the fluid tank is pressurized at the pressuring part by forming the fluid tank divided by the blade and partition walls in the impeller, in addition the incoming fluid to the fluid tank shall be moved to the neighboring fluid tank through the blade and bottom separation part, put the technical task of the invention in providing the impeller assembly for hydroelectric power generation device that the power generation efficiency is maximized by solving the point at issue such as the vacuum of the fluid in the pressurizing chamber causing a load on the impeller, etc. and completes this invention.

### Means of Solution of Task

As the means of solution of task, in this invention, the impeller is introduced in the main body of cylinder shape that the closed inner space is formed by the 1^{st} cover member, the driving shaft is supported by a bearing coupled to the cover member, in the impeller assembly for hydroelectric power generator that the impeller installed in the inner space shall be driven by forming the inlet and the outlet in the main body;

The abovementioned inlet, the fluid like the involute curve shall be supplied from the 12 o'clock direction to the 4 o'clock direction of the main body, the outlet is formed from 6 o'clock direction to 8 o'clock direction, the abovementioned impeller forms the plural fluid tanks opened toward the inner surface of the main body, it is characterized in that the moment of rotation of the impeller can be increased as the closed pressuring part shall be formed in the abovementioned fluid tank at the direction from 4 o'clock to 6 o'clock between the inlet and outlet.

Second, the abovementioned inlet, it is characterized in that the fluid can be evenly distributed and supplied to the fluid tank formed in the impeller by forming at least more than one inflow partition wall to the inside.

Third, at the end of the inflow partition wall, it is characterized in that it is composed to seal the part of the fluid tank formed in the impeller by forming a further inflow pressuring part.

Fourth, the abovementioned impeller, it is characterized in that the driving shaft and partition wall are coupled at the bottom, the driving shaft and the blades are spaced apart from each other.

Fifth, the abovementioned impeller, it is characterized in that the plurality of blades radially disposed to face the axial direction of the driving shaft to be close to the inner surface of the main body and in that a fluid tank partitioned by a plural partition walls disposed at an axial right angle with the driving shaft are provided.

Sixth, the abovementioned blade, it is characterized in that the top if formed to be curved in the opposite direction of rotation.

Seventh, in the front driving shaft of the abovementioned separation part, it is characterized in that an induction piece is formed in which the incoming fluid through the separation part is upward toward the fleet of the neighboring blade.

Eighth, the abovementioned blades, it is characterized in that the blade that the separation part with a narrow width formed between the driving shaft and the gap, that the separation part with a wide width wider than the separation part of a narrow width are alternately disposed.

Ninth, in the front driving shaft of the abovementioned separation part with a wide width, it is characterized in that the induction piece inducing the incoming fluid toward the middle direction of the neighboring blade through the separation part.

Tenth, the inner space of the abovementioned main body and the outer diameter of the impeller, it is characterized in that the flow loss may be minimized even though there is no rotation friction by composing so that the tolerance of 0.2˜0.5 mm may be maintained.

Eleventh, the driving shaft of the impeller, it shall be coupled through the bearing housing to be coupled in the cover member; the bearing housing forms the seal combination hole toward the cover member based on the partition wall, installs seals and bearings respectively by forming the bearing combination hole toward the opposite direction, the flow path is formed to be recessed horizontally under the seal combination hole, the emission hole is formed on the flow path so that the fluid leaking through the seal can be discharged to the outside.

Twelfth, it is characterized in that the means of pressurized adjustment is included further in the abovementioned pressuring part.

Thirteenth, the abovementioned means of pressurized adjustment, it is characterized in that the pressure adjustment hole formed in the pressuring part of the main body, it is inserted into the pressure adjustment hole and coupled to one end with a main body and a pin, the elevation means installed outside the main body to elevate the abovementioned adjustment member is included.

### The Effect of Invention

In case the impeller assembly for a hydroelectric power generation device provided by this invention is used, there is the effect as the following.
The inlet allows the fluid to be supplied like the involute curve from 12 o'clock direction to the 4 o'clock direction of the main body, in addition, the fluid may be distributed and supplied to the fluid tank formed in the impeller by forming more than one inflow partition wall evenly inside the inlet.
The fluid tank partitioned in the impeller is formed; the output efficiency may be increased as the moved fluid does the function pushing the blade through the separation part especially as the separation part is formed to the bottom of the fluid tank.
The flow loss may be minimized without the rotational friction of water wheel by composing to maintain the tolerance of 0.2˜0.5 mm between the inner surface of the main body and the tip of the blade with the inner surface of the main body and the tip of the blade composing the pressuring part.
In case it makes it compact and install in the small rivers of reservoirs, the small hydropower generation is possible.
The point at issue such as the excessive rotational force occurring in the impeller assembly, etc. may be resolved as the number of pressuring part can be adjusted according to the amount of the incoming fluid through the inlet as the means of pressurized adjustment has been equipped.

### SIMPLE EXPLANATION OF DRAWING

The drawing 1 is the appearance perspective view showing the desirable one implementation example of impeller assembly for hydroelectric power generation device provided by this invention.

The drawing 2 is the disassemble perspective view of drawing 1

The drawing 3 is the side section drawing of drawing 1

The drawing 4 is the side section drawing applied in this invention

The drawing 5 is the side section drawing showing other example of main body applied in this invention

The drawing 6 is the side section drawing showing another example of main body applied in this invention

The drawing 7 is the perspective view extracting the composition of impeller capable of applying in this invention

The drawing 8 is the longitudinal section drawing of drawing 7

The drawing 9 is the side section drawing of drawing 7

The drawing 10 is the side section drawing showing another example of impeller capable of applying in this invention

The drawing 11, the drawing 12 is the side section drawing showing another example of impeller capable of applying in this invention

The drawing 13 is the expanded cross section drawing showing the action of the induction piece equipped with the impeller applied in this invention

The drawing 14 is the cross section drawing showing the combination state of driving shaft and cover member of impeller applied in this invention

The drawing 15 is the side section drawing showing another example of the impeller assembly for hydroelectric power generation device provided by this invention

The drawing 16 is the flat cross section drawing extracting the means of pressurized adjustment in the drawing 15

The drawing 17 is the side section drawing extracting the means of pressurized adjustment in the drawing 15

### THE BEST FORM FOR THE IMPLEMENTATION OF INVENTION

It explains the desirable implementation example of the impeller assembly for hydroelectric power generation device provided by this invention pursuant to the attached drawing.

The drawing 1 illustrates the appearance perspective view showing one desirable implementation example of impeller assembly for hydroelectric power generation device provided by this invention, the drawing 2 illustrates the disassemble perspective view of drawing, the drawing 3 illustrates the side section drawing of drawing 1 and the drawing 4 illustrates the side section drawing of main body applied in this invention respectively.

The impeller assembly for hydroelectric power generation device (1) provided by this invention shall increase the rotational driving force of the impeller (4) by providing the pressure (weight) of the flow rate may be simultaneously provided to the impeller (4) together with the falling energy of the flowing rate.

This invention shall be realized by the combination of main body that the base plate (21) is equipped with, the cover member (3) sealing the inner space (22) formed in the main body (2) and the combination of impeller (4) to be installed in the inner space (22) with both ends supported in the abovementioned cover member (3).

The abovementioned main body (2) is composed of cylinder shape, the inner space (22) may be sealed that the cover member (3) is coupled to be watertight by a fixing means such as a stay bolt on both sides that are open.

The inlet (23) and the outlet (24) are formed in opposite directions to each other as illustrated in the drawing 4 in the main body (2), it is pressured (25) so that the closed pressuring part (25) may be formed by the blade (41) equipped with the impeller between the inlet (23) and the outlet (24).

The abovementioned inlet (23) is formed to be located between 12 o'clock to 4 o'clock direction, the flange (23a) is wholly formed in the upper part in the entrance of inlet (23).

The abovementioned inlet (23), the tube body is composed of a composition in which the tube body facing the direction of main body from the direction of flange (23a) is coupled with the main body (2) and an involute curve together, the fluid may be evenly distributed and supplied to the fluid tank (45) formed in the impeller by forming more than one inflow partition wall (23b) at least to the inside of the inlet (23).

Even though the example capable of supplying the plural fluid to the fluid tank (45) simultaneously when the impeller is rotated to the clockwise direction by forming 2 inflow partition walls (23b) to the horizontal direction is illustrated in this invention, it is natural that the number may increase as the occasion demands.

And at the end of the inflow partition wall (23b) of the abovementioned inlet (23), it can provide the composition sealing the part of fluid tank formed in the impeller (4) by forming the inflow pressuring part further as illustrated in the drawing 5. In case the inflow pressuring part (23c) is formed like this, it becomes to provide the effect of increasing the output efficiency by providing the functionality increasing the rotational force of impeller as the virtual pressure occurs instantaneously when it passes through the inflow pressuring part (23c) that the incoming fluid through the inlet in a state of being introduced into the fluid tank (45) formed in the impeller (4) as the divided state by the inflow partition wall (23b)

In addition, the outlet (24) shall be formed so that it may be located from 6 o'clock to 8 o'clock direction; the driving force rotating the impeller (4) with the fluid pressure shall be occurred by forming the pressuring part (25) to have an angle smaller than that of the inlet (23) between 4 o'clock and 6 o'clock direction

The drawing 6 illustrates the side section drawing showing another example of main body applied in this invention.

This, whereas more than one inflow partition wall (23b) is formed at least to the inside of the inlet (23) in composing the main body as abovementioned, the induction and supply of the incoming fluid shall be facilitated by differing the distance with the entrance direction of these inflow partition walls (23b).

Preferably, the length of the inflow partition wall (23b) shall be made to move away toward the inlet as it goes upward.

This composition shall allow the force driving the impeller (4) occur as the fluid is supplied first trough the space below when the fluid is flowed to the inlet (23), the rotational force of impeller (4) shall be improved by providing the functionality that the fluid supplied supplements and pressurizes through the upper space.

The drawing 7 illustrates perspective view extracting the composition of impeller capable of applying in this invention, the drawing Bis the longitudinal section drawing of drawing 7, the drawing 9 is the side section drawing of drawing 7, the drawing 10 to the drawing 12 illustrates the side section drawing showing another example capable of applying in this invention respectively.

The impeller (4) provided by this invention allows to rotate freely as the driving shaft (4a) located at the center is supported by the cover member (3) as mentioned above, the plural fluid tank (45) has the structure formed to be opened in the circumferential direction so that it shall be located in the inner space (22) formed in the main body (2).

The abovementioned impeller (4) is equipped with the plural blade in the driving shaft (4a), and the plural partition wall (42).

The blade (41) is disposed radially to be positioned in the axial direction of the driving shaft (4a) so that the driving shaft (4a) is close to the inner space of the main body (2); the partition wall (42) is disposed at an axial right angle with the driving shaft (4a).

The abovementioned plural partition wall (42) has the lower end coupled to the driving shaft (4a) in close contact with each other, it has the separated state each other as the blade (41) has a separation part (43) between the driving shaft (4a) and the gap. (please refer to the drawing 9)

The abovementioned separation part (43) may be provided as the diverse height according to the diameter of impeller (4) between the driving shaft (4a) and the gap.

The abovementioned separation part (43) may be composed to have the different height in the circumferential direction as necessary, the incoming fluid into the fluid tank (45) shall be discharged to the neighboring fluid tank (45) through the separation part (43) by disposing the blade (41) that the separation part (43) with a wide width is formed, the blade (41) that the separation part (43) wider width than the narrow width alternately

In case of abovementioned separation part, assuming that the narrow width is 10 mm, it is desirable that the wide width is the degree of 20 mm. (please refer to the drawing 10).

In addition, it shall be naturally induced toward the lower separation part when the incoming fluid to the inlet of main body by forming the curved composition in the opposite direction of rotation (counterclockwise in the coupled state) gradually when the blade (41) is seen as the cross-sectional provided by this invention.

In the meantime, an induction piece (44) is formed further on the side of the separation part formed in the bottom of blade (41) composing of the impeller (4), it provides the functionality increasing the rotational force by inducing this pressure to the middle part of blade located in the rotational direction (41) as the pressure occurs while passing through the narrow gap of the separation part (43) when the induction piece (44) is supplied to the neighboring fluid tank (45) through the separation part (43) (please refer to the drawing 11, the drawing 12 and the drawing 13).

In the meantime, the abovementioned induction piece (44) is installed in front of each separation part (43) uniformly, or can be installed one by one in turn. Especially in case the separation part (43) with different height is formed in turn, the induction piece (44) is formed in front of the high separation part (43) only.

And, in case of partition wall (42) that the bottom is coupled with the driving shaft (4a), it is composed of disk shape, it is coupled to both ends of the blade (41) and sealed, the fluid tank (45) with an open outside is formed by the blade (41) and the partition wall (42) as it is coupled at equal intervals between the partition wall disposed on both sides.

The composition in which four partition walls are equipped with is being proposed, the number and diameter of the abovementioned blade (41) and the number of partition wall (42) may be added or subtracted according to the size, etc. of the main body (2).

The flow rate shall be minimized without the rotational friction of the impeller (4) by composing the abovementioned outer diameter of impeller (4) shall be composed so that the internal diameter of main body (2) and the tolerance of 0.2˜0.5 mm may be maintained.

In case of tolerance less than the internal diameter of main body (2) and 0.2˜0.5 mm, the point at issue that the rotational force of impeller (4) decreases as the virtual pressure of fluid tank (45) located in the pressuring part (25) decreases in case of tolerance bigger than the internal diameter and 0.2˜0.5 mm.

In case the impeller (4) is composed as described above, the load occurs and the impeller stops as there is no mobility of fluid when it passes through the pressuring part (25) if the bottom is sealed when the supplied fluid is supplied to the partitioned narrow fluid tank (45) of impeller through the inlet (23), the smooth rotational force of impeller (4) may be guaranteed as it prevents the occurrence of loads as the fluid mobility inside the fluid tank (45) located in the pressuring part (25) is guaranteed since the part of the incoming fluid moves toward the neighboring fluid tank (45) of rotational direction through the inlet if the separation part (43) is formed as described above.

In addition, in case the size of separation part (43) is different, the action increasing the output is done by generating the driving force of the impeller (4) as it is being mixed with the fluid provided by the inlet (23) as the fluid movement between the fluid tanks (45) alternately speeds up and slows down.

Namely, the fluid is discharged to the opposite rotational direction (counterclockwise) through the separation part (23), the rotational force shall occur by pushing toward the pressuring part (25) of rotational direction while hitting the blade of rotational direction (41) of fluid tank (45) as it is joined with the incoming fluid through the inlet (23) in the induced state toward the top of blade of blade in the opposite direction of rotation through the induction piece (44).

The drawing 14 illustrates the cross-sectional drawing showing the combination state of driving shaft of impeller and cover member applied in this invention.

The driving shaft (4a) of the impeller (4) applied in the impeller assembly for hydroelectric power generation device is provided in the state that the bearing is supported in the cover member (3) coupled to both sides of the main body.

According to the illustrated, the driving shaft (4a) is coupled through the bearing housing to be coupled with the cover member (3), the improved composition is provided so that there may be no failure in relation to the bearing (32) by blocking the fluid leaking toward the bearing (32).

Namely, in case of bearing housing (31), the seal combination hole is formed toward the cover member (3) based on the partition wall (33), the seal (36) and the bearing (32) are installed respectively by forming the bearing combination hole (35) toward the opposite direction, the flow path (37) shall be formed to be recessed horizontally under the seal combination hole (34), the fluid leaking through the seal (36) shall be discharged to the outside by forming the emission hole (38) in the flow path (37), it is provided with the composition for blocking fluid from overflowing toward the bearing combination hole (35) toward the opposite direction by combining the fluid blocking ring (39) so that it may be close to the partition wall (33) to the inside the seal combination hole (34).

The point at issue such as the bearing (32) being corroded by a fluid, etc. as this composition has the composition discharging to the outside through the flow path (37) and the emission hole (28) formed in the seal combination hole even though the fluid is leaked through the seal (36) coupled in the driving shaft (4a).

The drawing 15 illustrates the side section drawing showing another example of the impeller assembly for hydroelectric power generation device provided by this invention, the drawing 16 is the flat cross section drawing extracting the means of pressurized adjustment in the drawing 15, the drawing 17 is the side section drawing extracting the means of pressurized adjustment in the drawing 15 respectively.

This shall include the means of pressurized adjustment (5) further in the pressuring part (25) in composing the impeller assembly (1) for hydroelectric power generation device as described above.

In case the means of pressurized adjustment (5) is installed in the pressuring part (25) as described above, the effect shall be provided capable of providing the output evenly by randomly regulating the pressure or the inflow rate of incoming fluid through the inlet (23).

If the composition of the means of pressurized adjustment (5) provided by this invention is checked, the pressure adjustment hole (25a) is formed to penetrate inside and outside in the pressuring part (25) of main body (2) and the adjustment member (51) is inserted into this pressure adjustment hole (25a).

This time, the adjustment member (51) shall be assembled by combining the outlet (24) is coupled with the main body (2) and the pin (52).

The abovementioned pressure adjustment hole (25a) has the shape extended by the guide part (53) coupled in the outside of main body, the adjustment member (51) is operated inside the guide part (53).

The abovementioned adjustment member that one end is coupled to the main body (2) and the pin (52) is assembled randomly by the means of elevation (54) with the pin (52) as the center.

The abovementioned means of elevation (54) combines the nut (56) in the support (55) installed horizontally in the guide part (53), the adjustment member (51) shall be elevated by screwing the adjustment bolt (51) coupled so that the fleet may be assembled in the nut (56).

In case the means of pressurized adjustment (5) is prepared as described above, the functionality capable of opening the part of fluid tank (45) formed in the impeller (4) in the pressuring part (25) as illustrated in the drawing 11.

Namely, when the excessive fluid flows in or the excessive pressure flows in through the inlet (23), this time, the overload may occur in the impeller (4), this time the operation efficiency of impeller assembly (1) by decreasing the output by controlling the quantity of fluid tank (45) located in the pressuring part (25) by adjusting the means of pressurized adjustment shall be maintained constantly.

Even though it explains the concrete implementation example in the detailed explanation of this invention, of course, the diverse deformation is possible within the limit not getting out of category of this invention. Therefore, the scope of protection of this invention should not be determined as it is limited to the explained implementation example, it should be determined by equal things as well as the scope of claims described later.

1. The impeller (4) is inserted into the main body (2) of cylinder shape that the sealed inner space is formed by the cover member (3), the driving shaft (4a) shall be supported by a bearing coupled to the cover member (3), in the impeller assembly for hydroelectric power generator in which the impeller installed in the inner space shall be driven by forming the inlet (23) and the outlet (24) in the main body (2) of cylinder shape that the inner space is formed by the cover member;
The abovementioned inlet (23), the fluid shall be supplied like the involute curve from 12 o'clock direction to 4 o'clock direction of main body (2), the outlet (24) is formed from 6 o'clock direction to 8 o'clock direction, the abovementioned impeller (4) forms the plural fluid tank (45) opened to the inner side of main body (2), the impeller assembly for a hydroelectric power generator is characterized in that the rotation moment of the impeller (4) shall be increased by forming the plural fluid tank (45) opened to the inner side of the main body (2) as the closed pressuring part (25) shall be formed in the abovementioned fluid tank at the direction from 4 o'clock direction to 6 o'clock direction between the abovementioned inlet (23) and the outlet (24) from 4 o'clock direction to 6 o'clock direction between the abovementioned inlet (23) and the outlet (4),

2. In the claim 1;
The impeller assembly for a hydroelectric power generation device is characterized in that the fluid shall be distributed and supplied evenly to the fluid tank (45) formed in the impeller (4) as the abovementioned inlet (23) forms more than one inflow partition wall (23b) at the least to the inside.

3. In the claim 2;
The impeller assembly for hydroelectric power generation device is characterized in that the part of the fluid tank (45) formed in the impeller (4) is composed to be sealed by forming the inflow pressuring part (23c) further at the end of the inlet partition wall (23b).

4. In the claim 1;
The impeller assembly for a hydroelectric power generation device is characterized in that the fluid tank (45) partitioned by the plural blade (41) to be disposed radially to be faced to the axial direction of driving shaft (4a) to be close to the inner surface of the main body (2) and by the plural partition wall (42) to be disposed at the right angle to the driving shaft (4a).

5. In the claim 4;
The abovementioned impeller (4), the lower ends of the driving shaft (4a) and the partition wall (42) are coupled, the impeller assembly for a hydroelectric power generation device is characterized in that driving shaft (4a) and blades (41) may be formed to the mutually fallen separation part (43)

6. In the claim 4;
The impeller assembly for a hydroelectric power generation device is characterized in that the upper end of abovementioned blade (41) is formed to be curved in the opposite direction of rotation.

7. In the claim 5;
The impeller assembly for a hydroelectric power generation device is characterized in that abovementioned blades (41), the blade (41) that the separation part of a narrow width (43) is formed between the driving shaft (4a) and the gap, the blade that the separation part with a wide width wider than the separation part of a narrow width are alternately disposed.

8. In the claim 5, the impeller assembly for a hydroelectric power generation device is characterized in that the induction piece (44) inducing the incoming fluid toward the fleet of neighboring blade (41) through the separation part (43) in the front driving shaft (4a) of the abovementioned separation part (43).

9. In the claim 8,
In the front driving shaft (4a) of the abovementioned separation part with a wide width (43), the impeller assembly for hydroelectric power generation device is characterized in that the induction piece (44) inducing the incoming fluid to the middle direction of neighboring blade (41) through the separation part.

10. In the claim 1, the impeller assembly for hydroelectric power generation device is characterized in that the flow loss may be minimized without the rotational friction of the impeller (4) by composing the inner side of the abovementioned main body (2)and the outer diameter of impeller so that the tolerance of 0.2˜0.5 mm may be maintained.

11. In claim 1;
The driving shaft (4a) of abovementioned impeller (4) is coupled through the bearing housing to be coupled in the cover member (3); the bearing housing (31) forms the seal combination hole (34) toward the cover member (3) based on the partition wall (33), the seal (36) and the bearing (32) shall be formed respectively by forming the bearing combination hole (35) toward the opposite direction, the impeller assembly for hydroelectric power generation device is characterized in that the fluid leaking through the seal (36) shall be discharged to the outside by forming the outlet (38) in the flow path (37) is formed to be recessed horizontally under the seal combination hole (34) by forming the emission hole (38) in the flow path (37)

12. In the claim 1;
The impeller assembly for hydroelectric power generation device is characterized in that the means of pressurized adjustment shall be included further in the abovementioned pressuring part (25).

13. In the claim 9;
The abovementioned means of pressurized adjustment shall be inserted in the pressure adjustment hole (25a) formed in the pressuring part (25) of main body (2), the abovementioned pressure adjustment hole (25a), the impeller assembly for hydroelectric power generation device is characterized in that the means of elevation (54) installed outside of main body (2) shall be included so that one end of the adjustment member (51) coupled with the main body (2) and the pin (52), the abovementioned adjustment member (51) shall be elevated.
